(19) United States
(12) Patent Application Publication
(10) Pub. No.: US 2019/0017316 A1
(43) Pub. Date: Jan. 17, 2019

(54) Foldable Blinds with Double Sheet Sets

(71) Applicant: Shaoxing Taiyu Textile Co., Ltd, Shaoxing (CN)

(72) Inventor: Qian Zhao, Shaoxing (CN)

(73) Assignee: Shaoxing Taiyu Textile Co., Ltd

(21) Appl. No.: 15/647,078

(22) Filed: Jul. 11, 2017

(51) Int. Cl. E06B 9/326; E06B 9/322; E06B 9/262

(52) U.S. Cl. CPC E06B 9/326; E06B 9/32; E06B 9/262; E06B 9/322

(57) ABSTRACT

A kind of foldable blind, including a top track, a bottom track, cord fabric between the top track and the bottom track, lift ropes and a line lock. Both ends of the top track and both ends of the bottom track are respectively equipped with a length compensation part to extend the length of the top track or the bottom track. The length from the end of the length compensation part that is far from the top track to the top track can be adjusted, while the length from the end of the length compensation part that is far from the bottom track to the bottom track can be adjusted. The topside and the bottom side of the cord fabric are respectively connected to the top track and the bottom track, and there are fastening parts between the length compensation parts and the cord fabric.

### BACKGROUND

The present disclosure generally involves blinds, especially a kind of foldable blinds and foldable blinds with double sheet sets.

Foldable blinds are screen-style blinds that can be unfolded and folded. It can provide a larger area of shade and sunlight reflection than other kinds of blinds or curtains. Thus, it functions well in sunshade and sound insulation. Foldable blinds include shutters, honeycomb blinds, etc.

Currently, a kind of shutters was disclosed under Chinese Patent No. CN203925238U (license announcement date: Nov. 5, 2014), including top tracks, a movable track, rivet buttons, springs, cord fabric, top track side seal caps, movable track side seal caps, lift ropes for rise and fall and fastening buttons. Among others, the upper end and the lower end of the cord fabric are respectively fastened on the top track and the movable track with rivet buttons. A spring is placed inside the top track in the middle. There are lift ropes for rise and fall on both ends of the spring. The other end of each lift rope for rise and fall goes through a through hole A in the middle of the top track, then goes through a rope through hole on the cord fabric from top to bottom, and finally goes through a through hole B on both sides in the middle of the movable track into the movable top track and then goes through a through hole C on the movable track side seal cap on each end of the movable track crosswise. A fastening button is done on the end of each lift rope for rise and fall.

Though this kind of shutters can help adjust the height of the cord fabric through the adjustment of the lift rope for rise and fall, as the width of each type of window may differ, when foldable blinds are installed on a window, the dimensions of the window shall be measured in the first place, and foldable blinds of certain dimensions adaptable to the window shall then be customized. In this case, the installation of foldable blinds is complicated, and the work shall be operated by professionals, incurring significant labor costs.

### SUMMARY

Disclosed in one embodiment is a foldable blind, comprising a top track having a top track inside wall, a top track outside wall, a top track first end and a top track second end, a top length compensation portion connected to the top track having a top length compensation inner portion and a top length compensation outer portion, wherein a top length of the top length compensation portion is adjustable, a bottom track having a bottom track inside wall and a bottom track outside wall, a bottom track first end and a bottom track second end, a bottom length compensation portion connected to the bottom track having a bottom length compensation inner portion and a bottom length compensation outer portion, wherein a bottom length of the bottom length compensation portion is adjustable, a cord fabric located between the top track and the bottom track, wherein a cord fabric topside is connected to the top track and a cord fabric bottom side is connected to the bottom track, a plurality of lift ropes, connected to the top track, a plurality of fasteners located between the top length compensation portion and the cord fabric topside and located between the bottom length compensation portion and the cord fabric bottom side and a line lock located in the top track and engageably coupled with the lift ropes. In installation, no customization of cord fabric is needed, which helps save cost and time. In the meanwhile, the top track can be installed directly through the second double faced adhesive tape and the third double faced adhesive tape, which makes installation easier.

### BRIEF DESCRIPTION OF THE DRAWINGS

FIG. 1 is a structural diagram of Embodiment 1;

FIG. 2 is a structural diagram of the top tracks in Embodiment 1;

FIG. 3 is a partial enlarged drawing of Position A of Embodiment 1 in FIG. 2;

FIG. 4 is a structural section view of the line lock in Embodiment 1;

FIG. 5 is an exploded view of Embodiment 1;

FIG. 6 is a structural diagram of Embodiment 2;

FIG. 7 is a structural diagram of the top tracks in Embodiment 2;

FIG. 8 is a an exploded view of Embodiment 2;

FIG. 9 is a structural diagram of Embodiment 3;

FIG. 10 is a structural diagram of Embodiment 4;

In the figures: 1. top track; 11. track trough; 12. trough hole; 2. bottom track; 3. cord fabric; 4. lift rope; 41. pull ring; 42. spacing rod; 5. line lock; 51. installation platform; 511. installation cavity; 52. roller; 53. jugging trough; 54. jugging axis; 55. spacing part; 6. length compensation part; 61. foam strip; 611. first hard foam plate; 612. second hard foam plate; 613. second double faced adhesive tape; 614. third double faced adhesive tape; 62. supporting track; 621. connecting trough; 7. fastening part; 71. first double faced adhesive tape; 72. fourth double faced adhesive tape; 8. wire part; 81. wire platform; 82. pin axis; 9. connection part; 91. connection strap; 911. fastening hole; 92. spacing strap; 10. adjustment part; 101. first adjustment arm; 102. second adjustment arm; 103. adjustment rod; 104. snap-fit block.

### DETAILED DESCRIPTION

This disclosure provides a kind of foldable blinds with adjustable width.

This is a kind of foldable blinds, including a top track, a bottom track, cord fabric between the top track and the bottom track, lift ropes and a line lock. It is characterized by the fact that: Both ends of the top track and both ends of the bottom track are respectively equipped with a length compensation part. The length from the end of the length compensation part that is far from the top track to the top track can be adjusted, while the length from the end of the length compensation part that is far from the bottom track to the bottom track can be adjusted. The topside and the bottom side of the cord fabric are respectively connected to the top track and the bottom track, and there are fastening parts between the length compensation parts and the cord fabric.

There are length compensation parts on both end of the top track and the bottom track, and the length from the end of the compensation part that is far from the top track to the top track is adjustable. Thus, before the blinds are installed on the window, when the dimensions of the window is determined, choose foldable blinds whose maximum length after the top tracks and the two length compensation parts are well matched is larger than the width of the window. Then adjust the positions of the length compensation parts, cut the cord fabric with a paper knife, and fasten the length compensation parts and the cord fabric with a fastening part, so as to adjust the width of the foldable blinds; and the foldable blinds can thus be installed on windows of different widths. In the meanwhile, in order to ensure the cord fabric is foldable, generally, we choose harder cloth or starched soft cloth. Thus, the end face of the cord fabric is quite smooth after the cord fabric is cut.

The length compensation parts are used to fasten and connect foam trips on both ends of the top track and both ends of the bottom track, and the fastening part is the first double faced adhesive tape between the foam strips and the cord fabric. Before the foldable blinds are installed, measure the width of the window, and choose foldable blinds that are no shorter than the width of the window when two foam strips are added to the top track. Then cut the foam strips on both ends of the top track, foam strips on both ends of the top track and the cord fabric 3 with a paper knife and other tools, so that the width of the foldable blinds is adaptable to the width of the wind and realize the adjustment of the width of the foldable blinds, which makes installation easier.

A first hard foam plate is bonded between the same wall of the two foam strips on both ends of the top track and the wall opposite to the top track (2), and a third hard foam plate is bonded between the same wall of the two foam strips on both ends of the bottom track and the wall opposite to the bottom track (2).

the first hard foam plate and the second hard foam plate can increase the strength of the foam strips, so that the foam strips are not likely to crack. Besides, the first hard foam plate and the second hard foam plate are made of foam materials. Thus, when the foam strips are cut with a paper knife, it is easy to cut the first hard foam plate and the second hard foam plate.

A second double faced adhesive tape not taken apart yet is bonded between the wall of the end of each of the two foam strips of the top track (2) that is far from the first hard foam plate and the wall opposite to the top track (2), and a third double faced adhesive tape not taken apart yet is bonded between the wall of the end of each of the two foam strips of the top track (2) that is far from each end of the bottom track (2) and each end of the top track (2) and the bottom track (2).

The second double faced adhesive tape and the third double faced adhesive tape can increase the connection strength between the foam strips and the top track on one hand; on the other hand, when the second double faced adhesive tape and the third double faced adhesive tape are dismantled, the top tracks can be pasted on the window for installation through the second double faced adhesive tape and the third double faced adhesive tape, which makes installation easier.

There are two lift ropes; both ends of the top track (2) are symmetrically equipped with wire parts for the lift ropes to bypass a pin axis; the lift ropes are connected to the bottom track (2) on one end, and bypasses the cord fabric (3), the top track (2) and the pin axis one by one before entering the line lock on the other end; the top track (2) and the pin axis then enter the line lock and the line lock is equipped on the top track (2) and between the foam strips and the wire parts.

The pin axis can reduce the friction force of the dipping ropes in drilling, so that the lift ropes can be pulled more smoothly.

The length compensation parts are used to adjust the length of a supporting track on both ends of the top track and both ends of the bottom track, and the fastening part is the fourth double faced adhesive tape not taken apart yet, which is bonded on the cord fabric.

Before the installation of the foldable blinds, measure the width of the window first, choose foldable blinds whose total length including the top tracks and the two supporting tracks is no smaller than the width of the window, cut the cord fabric with a paper knife, adjust the position of the supporting track so that the supporting track is in a proper position, open the fourth double faced adhesive tape on the cord fabric so that the top tracks and the cord fabric are bonded with each other through the fourth double faced adhesive tape, and finally realize the adjustment of the width of the cord fabric, which makes installation easier.

There are two lift ropes; the supporting tracks has a connecting trough parallel with the supporting tracks; there are two through-holes on the bottom track for the two lift ropes to go through; and when the length of the supporting tracks is adjusted, the through-holes and the connecting trough coincide, and the line lock is equipped on the end of any supporting track on the top track that is far from the top track.

A line lock is placed on an end of the supporting track that is far from the top track, so that the dipping ropes are at one end of the blinds after going through the line lock to make it easier for the cord fabric to be folded and unfolded. In the meanwhile, there is a connecting trough on the supporting track, so that when the supporting track is at different places of the top track, the lift ropes can enter the line lock, passing the through hole and the connecting trough.

The line lock includes an installation platform with an installation cavity, a roller connected to the installation platform and located on an end of the installation cavity in a rotary manner, a jugged trough on the inner wall of the installation cavity on an end far from the roller, a jugged axis installed in the installation cavity in a flexible manner and meshing with the jugged trough, and a spacing part fastened on the installation platform and going through the bottom of the installation cavity to prevent the jugged axis from falling out. The aperture between the upper aperture of the jugged trough and the roller is smaller than the jugged axis; the jugged trough is in an arc shape and the bottom extends at a direction away from the roller; and the two lift ropes go through the space between the roller and the jugged axis and then go through both sides of the spacing part.

When the lift ropes are pulled down vertically, the lift ropes drive the jugging axis to move downwards along the jugging trough with friction force, and get away from the roller due to the extension direction at the bottom of the jugging trough gradually, so that the jugging axis is separated from the lift ropes gradually to realize the folding and unfolding of the cord fabric. When the lift ropes are relaxed vertically, they move upwards directly, and the cord fabric will drop down and get unfolded. When the lift ropes tilt away from the roller and are relaxed again, the lift ropes will produce an upward friction force to the jugging axis, and the jugging axis will move upwards along the jugging trough. Here, as the aperture on the upper end of the installation cavity is small, when the jugging axis moves upwards to the largest extent, the lift ropes are clamped between the jugging axis and the roller, so that the lift ropes are fastened; in the meanwhile, the two lift ropes go through both sides of the spacing part, so that the two lift ropes will not intertwine with each other when being conveyed between the jugging axis and the roller, and failure in the line lock due to the intertwining of the two lift ropes will not happen.

Both sides of the cord fabric (3) are connected to the top track (2) and the bottom track (2) in a detachable manner; the end near the bottom track (2) of each lift ropes has a spacing rod for going through the bottom track (2); each of the lift ropes is connected with the spacing rod in the middle of the spacing rod; and ends of the two lift ropes that go through the line lock are connected with each other and fastened with a pull ring. The cord fabric is connected between the top tracks and the bottom tracks in a detachable manner, so that the cord fabric can be replaced and different kinds of cord fabric can be used for the foldable blinds; besides, the spacing rod can go through the cord fabric, and lift ropes are connected to the middle of the spacing rod, so that they can be connected to the bottom tracks through the spacing rod.

The instant disclosure provides a kind of foldable blinds with double sheet sets with light regulation.

This is a kind of foldable blinds with double sheet sets, including two foldable blinds described herein. There is an adjustment part between two of the top tracks (2) for the adjustment of the distance between two of the top tracks (2). Any of the cord fabric (3) is made of opaque textile processed by starching, and the other cord fabric (3) is made of long-fiber Dacron textile processed by starching. The adjustment part includes multiple first adjustment arms connected to any of the top tracks (2) through hinge joint on one end, a multiple second adjustment arms connected to the other of the top tracks (2) through hinge joint on one end and connected to the first adjustment arms through hinge joint on the other end, an adjustment rod is fastened among the first adjustment arms, there is a snap-fit block on the top tracks (2) close to the first adjustment arms, and one end of the adjustment rod is fastened inside the snap-fit block after rotation.

As the thickness of different parts of the wall of the window varies, the space between the two top tracks can be adjusted through an adjustment part, so that the two top tracks can be installed at different parts of the window that vary by thickness; meanwhile, a cord fabric piece is made of opaque cloth, while the other is made of hard yarn or starched Dacron long-fiber nonwovens. When the cord fabric piece made of opaque cloth is folded, the cord fabric piece of hard yarn can increase the transparency while ensuring the privacy, and at the same time increase ventilation; the cord fabric piece made of Dacron long-fiber nonwovens also has certain transparency, so that part of the light can enter into the room; starching processing is for increasing the hardness of the cord fabric, so that the cord fabric can be processed and finished in a pleat making machine; meanwhile, for cord fabric that has been processed with starching, the end face is also flat and looks beautiful after cutting.

To sum up, the width of the foldable blinds can be directly adjusted, so that they are adapted to windows of different widths. In installation, no customization of cord fabric is needed, which helps save cost and time. In the meanwhile, the top track can be installed directly through the second double faced adhesive tape and the third double faced adhesive tape, which makes installation easier.

### SPECIFIC EMBODIMENT METHODS

This disclosure is further described in detail according to the attached figures as follows:

### Embodiment 1

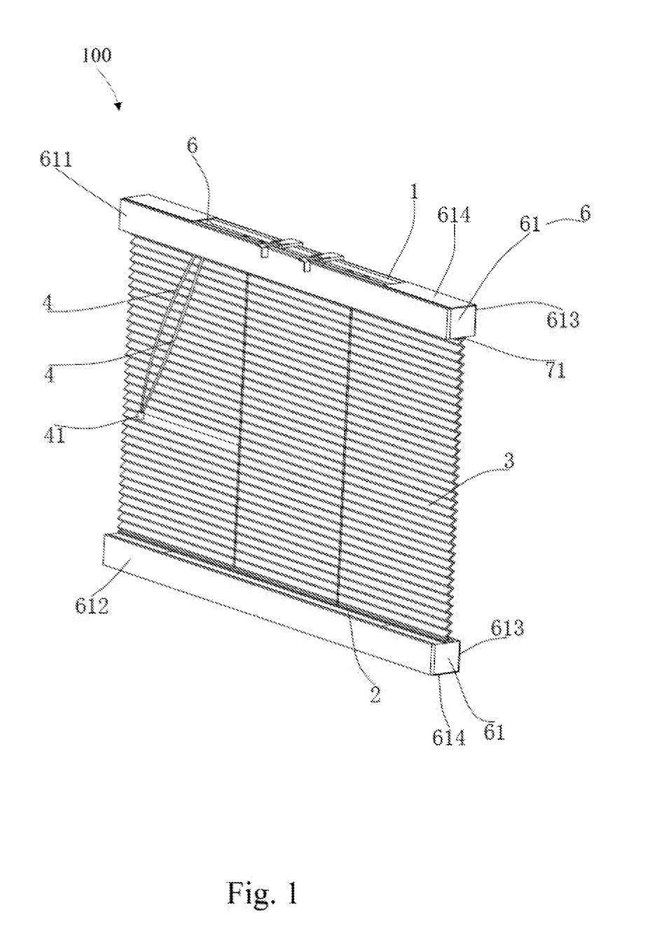

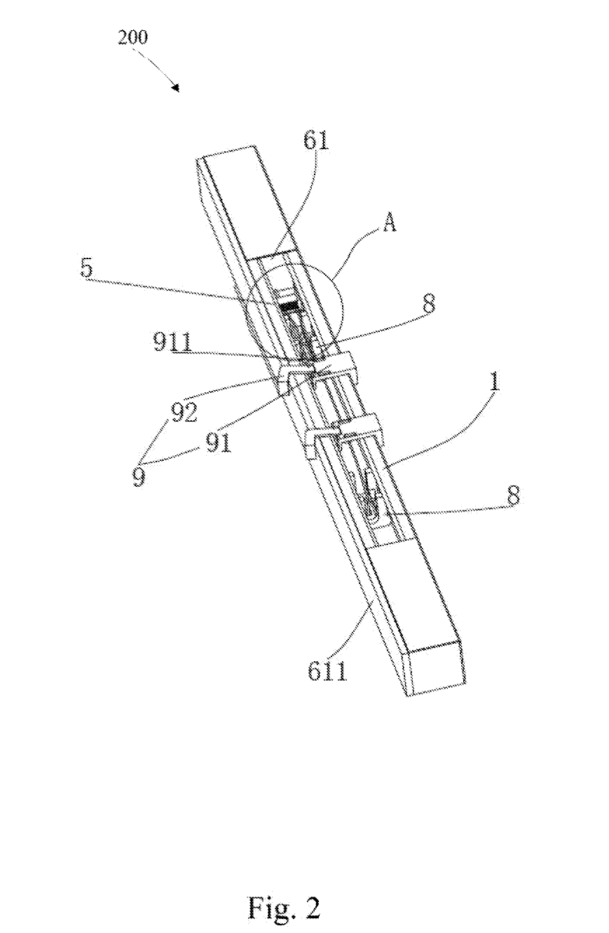

A kind of foldable blinds (see FIG. 1 and FIG. 2), including top tracks 1, bottom tracks 2, cord fabric 3, lift ropes 4 and line lock 5 (see FIG. 2). The upper side and lower side of cord fabric 3 are connected to a position between a top track 1 and a bottom track 2 with a hook & loop (now shown in the figures) or a double faced adhesive tape (not shown in the figures) in a detachable manner. In the meanwhile, both ends of the top track 1 and both ends of the bottom track 2 are respectively equipped with a length compensation part 6. The part of the length compensation part 6 between the top track 1 and the bottom track 2 is adjustable. Besides, the width of the cord fabric 3 is larger than that of the top track 1, and the upper end and the lower end of cord fabric 3 are respectively connected to each length compensation part 6 via a fastening part 7.

A track trough 11 shaped as a Chinese character “ [symbol] ” in the cross section is formed on the end that is relatively far on the top track 1 and the bottom track 2, and the track trough 11 extends along the length direction of the top track 1 and goes through both ends of the top track 1. The length compensation 6 is a foam strip 61 inserted into the track trough 11 on one end. The fastening part 7 is a first double faced adhesive tape 71 for the bonding between both the upper side and the lower end of the cord fabric 3 and the foam strips 61.

The length of the part of each of the two foam strips 61 on both ends of the top track 1 is the same; in the meanwhile, there is a first hard foam plate 611 bonded between the same wall of the two foam strips 61 and the wall opposite to top track 1. The length of the part of each of the two foam strips 61 on both ends of the bottom track 2 is the same; in the meanwhile, there is a second hard foam plate 612 bonded between the same wall of the two foam strips 61 and the wall opposite to bottom track 2. The first hard foam plate 611 and the second hard foam plate 612 are on the same side.

There is a second double faced adhesive tape 613 that is not taken apart yet bonded between the other side wall of the two foam strips 61 on both sides of the top track 1 and the wall opposite to top track 1; besides, there is a third double faced adhesive tape 614 that is not taken apart yet bonded between the end face of the two foam strips 61 far from the bottom track 2 and the end face of the top track 1 far from the bottom track 2 respectively. There is a second double faced adhesive tape 613 that is not taken apart yet bonded between the other side wall of the two foam strips 61 on both sides of the bottom track 2 and the wall opposite to top track 1; besides, there is a third double faced adhesive tape 614 that is not taken apart yet bonded between the end face of the two foam strips 61 far from the top track 1 and the end face of the bottom track 2 far from the top track 1 respectively.

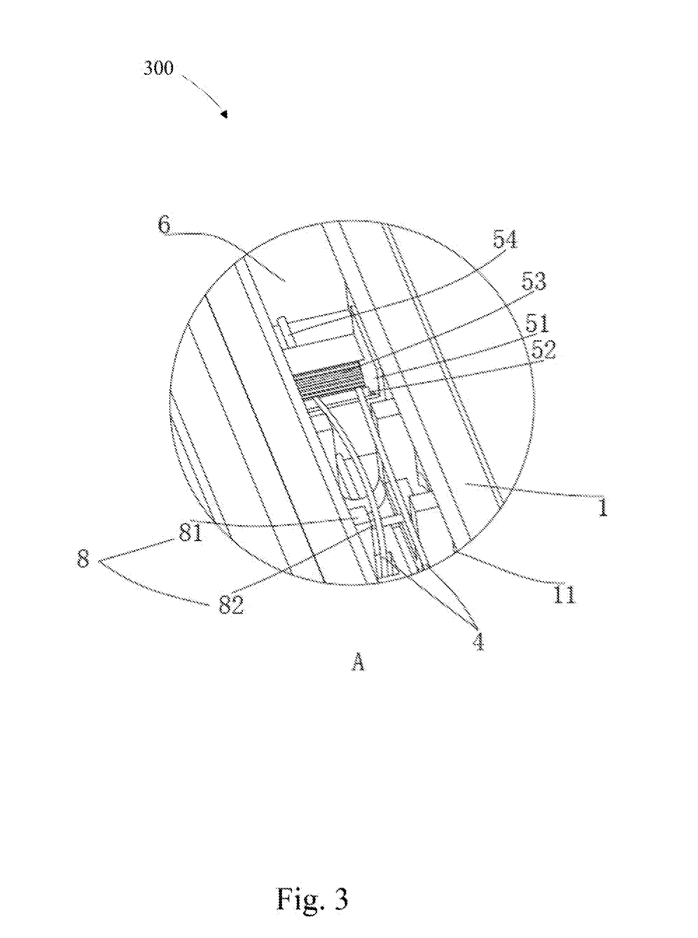

See FIG. 2 and FIG. 3, there are two wire parts 8 symmetrically installed within the track trough 11 of the top track 1. A wire part 8 includes a wire platform 81 made of plastics inside the track trough 11 in a snap-fit manner, and a pin axis 82 vertical to the length of the track trough 11 that is fastened on the wire platform 81.

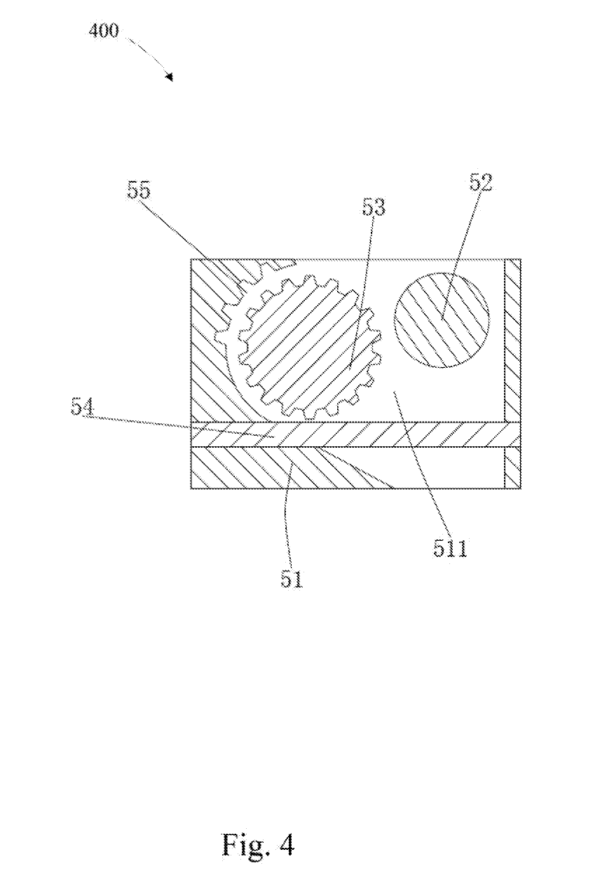

See FIG. 2 to FIG. 4, there is a line lock 5 between the foam strip 61 and a wire part 8 close to such foam strip 61 inside the track trough 11 of the top track 1. The line lock 5 includes an installation platform 51 with an installation cavity 511 that is built in the track trough 11, a roller 52, a jugging axis 54, a jugging trough on the inner wall of the installation cavity 511, and a spacing part 55. The roller 52 is connected to the installation platform 51 by the rotation of a pin roll (not shown in the pictures) and is located at a position inside the installation cavity 511 that is close to the wire part 8; the jugging axis 54 is connected to the inside of the installation cavity 511 in a flexible manner; the jugging trough 53 is on the inner wall of the installation cavity 511 far from the roller 52, for meshing with the jugging axis 54; the jugging trough 53 is in an are shape, and its bottom end extends at a direction far from the roller 52. The aperture between the upper end face of the installation cavity 511 and the roller 52 is smaller than the size of the saw-tooth, so that the jugging 54 cannot go through the upper end of the installation cavity 511. The spacing part 55 is an iron wire. Both ends of the iron wire are fixed on the installation platform 51 and go through the lower part of the installation cavity 511 to prevent the jugging axis 54 from falling out.

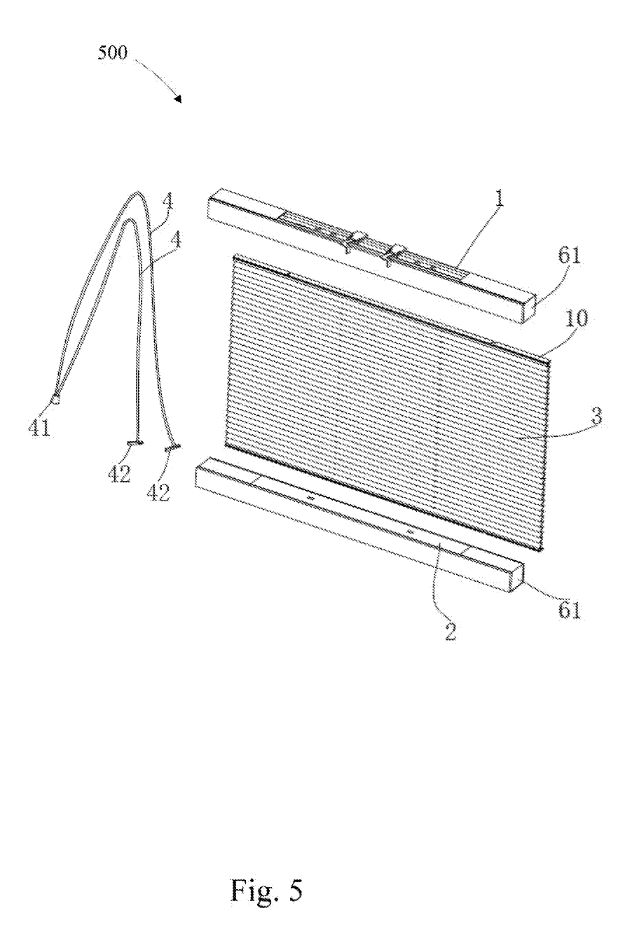

See FIG. 3 to FIG. 5, there are two lift ropes 4 in total. The two lift ropes 4 pass by the bottom track 2, the cord fabric 3, the top track 1 and the pin axis 82, and enter into the line lock 5 at the same time. When the two lift ropes 4 enter into the line lock 5, the two lift ropes 4 go through the space between the jugging axis 54 and the roller 52, and the two lift ropes 4 go through the line lock 5 from both sides of the spacing part 55 respectively. In the meanwhile, the two lift ropes 4 go through one end of the line lock 5 and are fastened there, where there is a pull ring 41; after the end of each lift rope 4 near the bottom track 2 is wrapped, it is connected to a spacing rod 42 by jamming, which is used for going through the bottom track 2, and the joint between the lift rope 4 and the spacing rod 42 is in the middle of the spacing rod 42.

When the lift ropes are pulled down vertically, the lift ropes 4 drive the jugging axis 54 to move downwards along the jugging trough 53 with friction force, and get away from the roller 52 due to the extension direction at the bottom of the jugging trough 53 gradually, so that the jugging axis 54 is separated from the lift ropes 4 gradually to realize the folding and unfolding of the cord fabric 3. When the lift ropes 4 are relaxed vertically, they move upwards directly, and the cord fabric 3 will drop down and get unfolded. When the lift ropes 4 tilt away from the roller 52 and are relaxed again, the lift ropes 4 will produce an upward friction force to the jugging axis 54, and the jugging axis 54 will move upwards along the jugging trough. Here, as the aperture on the upper end of the installation cavity 511 is small, when the jugging axis 54 moves upwards to the largest extent, the lift ropes 4 are clamped between the jugging axis 54 and the roller 52, so that the lift ropes 4 are fastened.

See FIG. 2. There are also two connection parts 9 installed on the top track 1; the connection part 9 includes a connection strap 91 and a spacing strap 92 connected to the connection strap 91 in a rotary manner. There is a fastening hole 911 on the connection strap 91; one end of the connection strap 91 presses against a position near the corner of the track trough 11 of the first hard foam plate 611, and the inner wall of the other end presses against the side wall of the top track 1 that is far from the first hard foam plate 611; the spacing strap 92 is at a position far from a bend of one end of the connection strap 91, and presses against the first hard foam plate 611 after rotation.

Process of implementation: Before the installation of the foldable blinds, choose a model that is at least as wide as the window. Then measure the width of the window. Cut the two foam strips 61 on both ends of the top track 1 and the two foam strips 61 on both ends of the bottom track 2 with a paper knife. By this means, the width of the cord fabric 3 can be adapted to the width of the window, so that the width of the cord fabric 3 matches the width of the window.

In the installation of the foldable blinds, the foldable blinds can be fastened by being bonded with the second double faced adhesive tape 613 and the third double faced adhesive tape 614 on the top track 1 directly, or fastened via the fastening hole 911 on a bolt, nut and other supporting connection parts 9.

### Embodiment 2

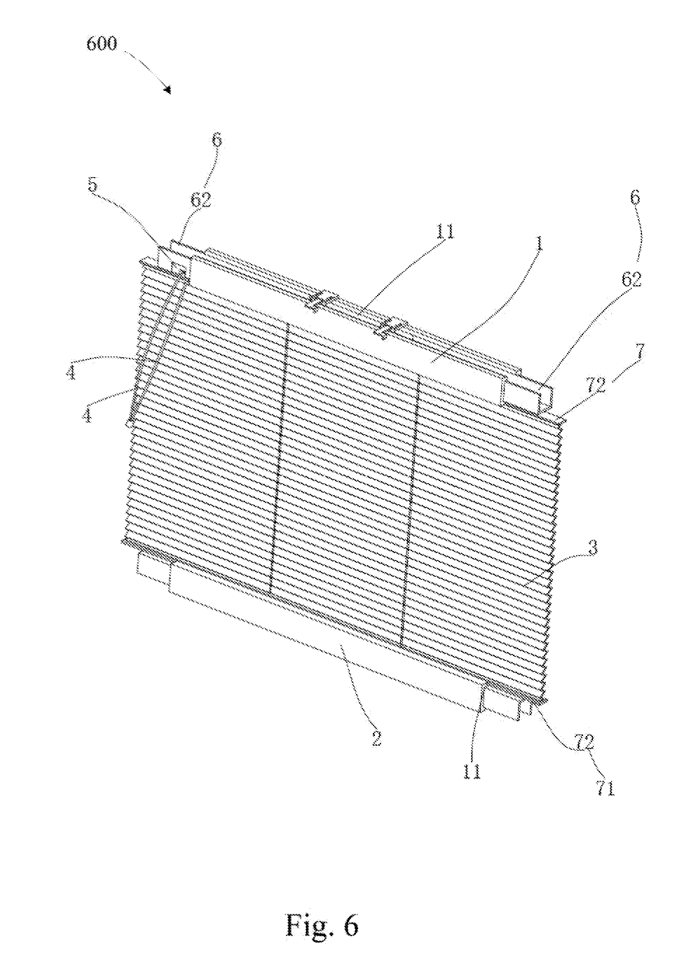

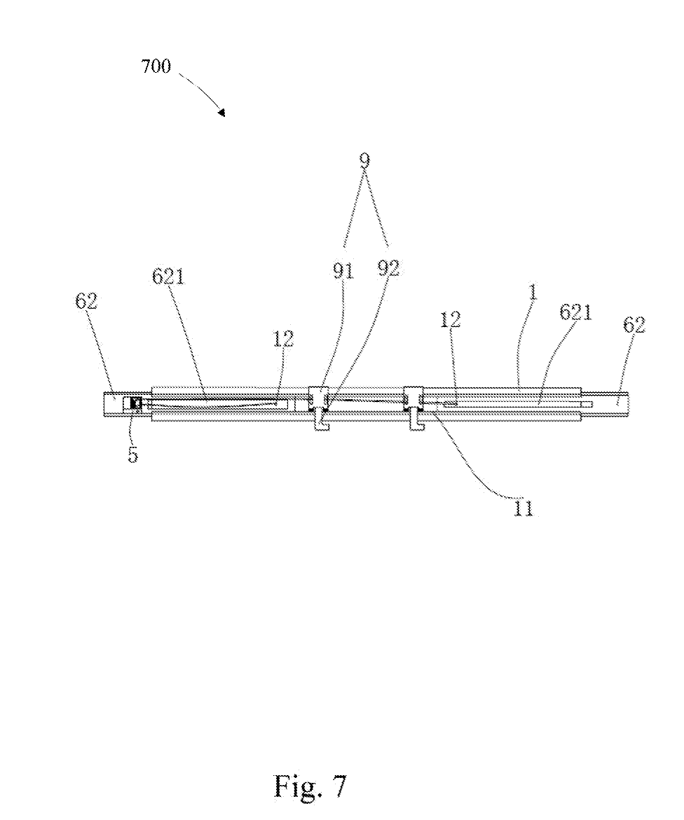

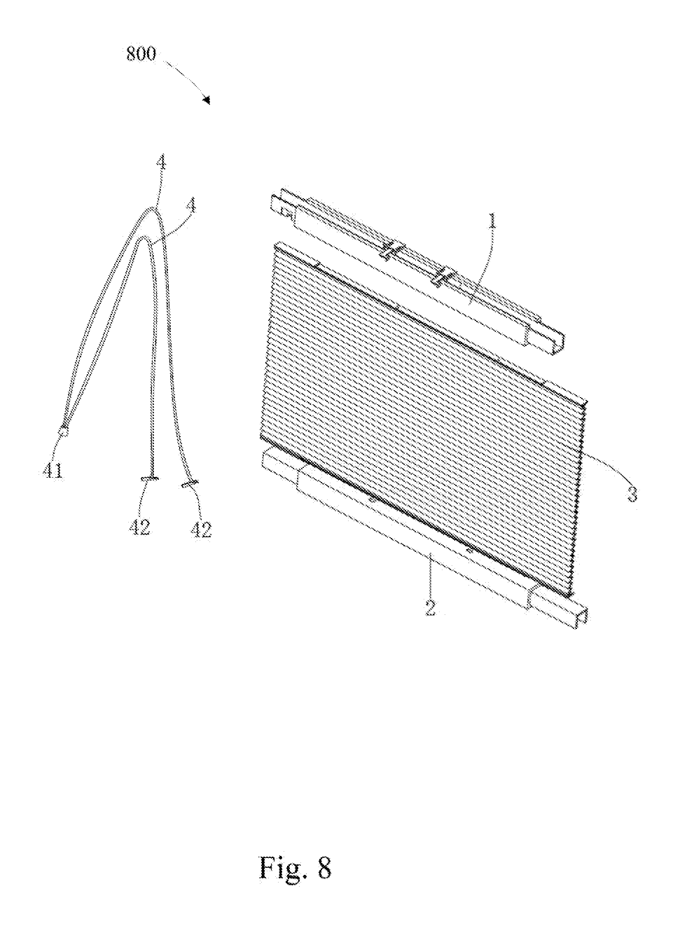

Differences from Embodiment 1: See FIG. 6, FIG. 7 and FIG. 8, there is no wire part 8 (see FIG. 3) on the top track 1; meanwhile, the length compensations 6 are the supporting track 62 on both ends of the track trough 11 on the top track 1 and both ends of the track trough 11 on the bottom track 2, and the fastening 7 is the fourth double faced adhesive tape 72 that is not taken apart yet bonded on the cord fabric 3.

There is a connecting trough 621 parallel with the supporting tracks 62 on the two supporting tracks on both ends of the top track 1 there are two through holes 12 on the top track 1, and when supporting tracks 62 slide, the connecting trough 621 and the through hole 12 on the supporting tracks 62 coincide. One end of each lift rope 4 is connected on the bottom track 2 and the other end goes through the cord fabric 3, the through hole 12 and the connecting trough 621 one by one. Besides, the line lock 5 is on one end of a supporting track 62 on the top track 1 that is far from the top track 1.

Here, the fastening position of the connecting part 9 on the top track 1 also changes. One end of the connection strap 91 presses against the corner of the track trough 11, and the inner wall of the other end presses against the side wall of the top track 1. The end of the spacing strap 92 far from the connection strap 91 is used to press against the side wall of the top track 1 for fastening after rotation. The spacing strap 92 is near the connection part 9, and is used to press against one end at the corner of the track trough 11, so that the connection part 9 is fastened on the top track 1.

Process of implementation: Before the installation of the foldable blinds, choose a model that is at least as wide as the window. Then measure the width of the window. Cut the cord fabric 3 so that the width of the cord fabric 3 matches the width of the window. Then make the supporting track 62 slide inside the track trough 11. Finally, open the fourth double faced adhesive tape 72 on the cord fabric 3, so that the cord fabric 3 and the supporting track 62 are fastened together.

### Embodiment 3

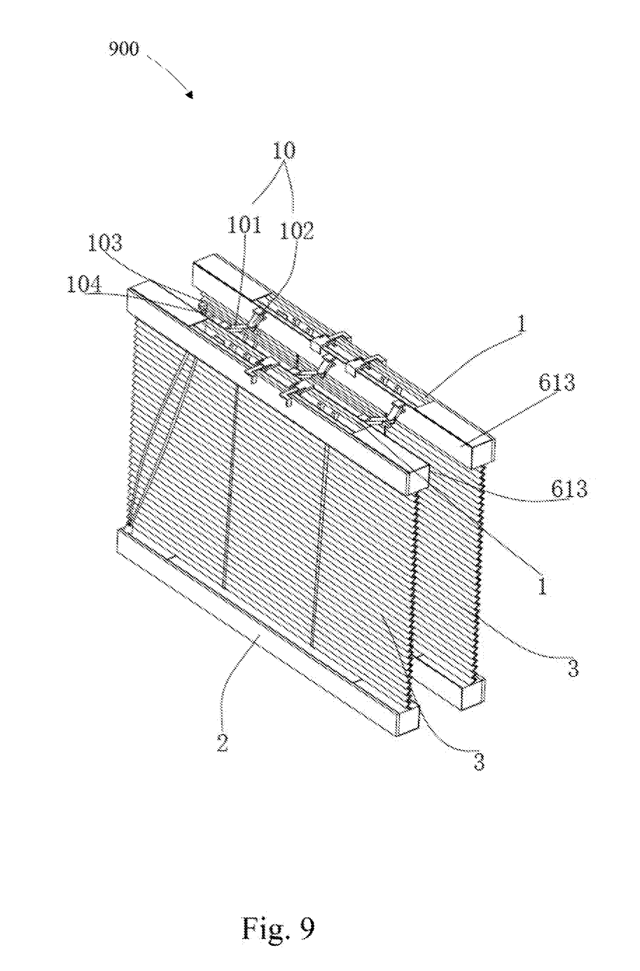

A kind of foldable blinds with double sheet sets (see FIG. 9), including two sets of foldable blinds described in Embodiment 1; and there is an adjustment part 10 between the two top track 1s for the adjustment of the space between the two top track 1s. The adjustment part 10 includes multiple first adjustment arms 101 connected to either top track 1 through a pin roll (not shown in the figures) by means of hinge joint, and multiple second adjustment arms 102 with one end connected to the other top track 1 by means of hinge joint and with the other end connected to the first adjustment arms 101 through a pin roll (not shown in the figures) by means of hinge joint. Both the first adjustment arm 101 and the second adjustment 102 are connected to the top track 1 by means of hinge joint and bonded to the side wall of the second double faced adhesive tape 613. The space between the two top track is can be adjusted with the adjustment part 10, so that the two top track 1s can match the thickness of the wall at the window for installation.

There is an adjustment rod 103 among the multiple first adjustment arms 101; there is a snap-fit block fastened on the top track 1 close to the first adjustment arms 101; one end of the adjustment rod is fastened inside the snap-fit block 104 after rotation with the first adjustment arms 101.

In the meanwhile, a cord fabric piece is made of opaque cloth, while the other is made of starched Dacron long-fiber nonwovens. As for the double-layer cord fabric 3, when the piece made of opaque cloth is folded and the piece made of starched Dacron long-fiber nonwovens is unfolded, due to the heat-resistant, anti-aging and ultraviolet-proof performance as well as the certain transparency of the Dacron long-fiber nonwovens, part of the light can enter into the room. Besides, there is no hole in the Dacron long-fiber nonwovens, which can prevent dust and other matters from entering into the room with wind. Starching is for increasing the hardness of the cord fabric 3, to facilitate the pleat-making for the cord fabric 3 with a pleat making machine.

### Embodiment 4

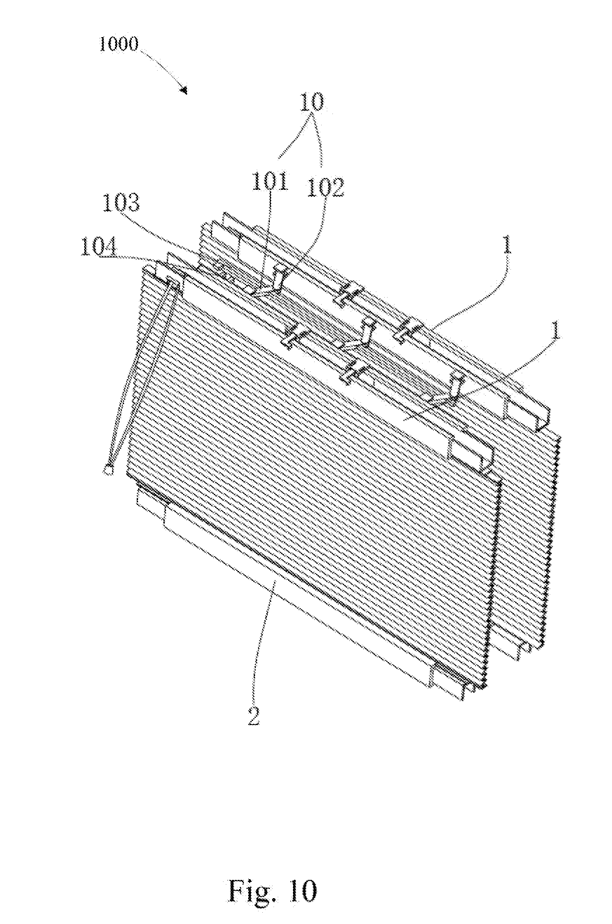

Difference from Embodiment 3 (see FIG. 10): It consists of two pieces of foldable blinds described in Embodiment 2.

The preceding embodiments are non-limiting examples. After reading this specification, technicians in this field may make amendments without any creative contributions to these embodiments as needed, provided that any content that falls within the scope of the claims of this invention shall be protected by the patent law.

What is claimed is:

1. A foldable blind, comprising:
a top track having a top track inside wall, a top track outside wall, a top track first end and a top track second end;
a top length compensation portion connected to the top track having a top length compensation inner portion and a top length compensation outer portion, wherein a top length of the top length compensation portion is adjustable;
a bottom track having a bottom track inside wall and a bottom track outside wall, a bottom track first end and a bottom track second end;
a bottom length compensation portion connected to the bottom track having a bottom length compensation inner portion and a bottom length compensation outer portion, wherein a bottom length of the bottom length compensation portion is adjustable;
a cord fabric located between the top track and the bottom track, wherein a cord fabric topside is connected to the top track and a cord fabric bottom side is connected to the bottom track;
a plurality of lift ropes, connected to the top track;
a plurality of fasteners located between the top length compensation portion and the cord fabric topside and located between the bottom length compensation portion and the cord fabric bottom side; and
a line lock located in the top track and engageably coupled with the lift ropes.

2. The foldable blind of claim 1 further comprising:
a plurality of foam strips fastened to the top track first end, the top track second end, the bottom track first end and the bottom track second end; and
a first double faced adhesive tape bonded by at least one of the plurality of fasteners between the plurality of foam strips and the cord fabric.

3. The foldable blind of claim 2 further comprising:
a first hard foam plate bondable to the top track inside wall and the top length compensation inner portion adjacent the top track first end and the top track second end; and
a third hard foam plate bondable to the bottom track inside wall and the bottom length compensation inner portion adjacent the bottom track first end and the bottom track second end.

4. The foldable blind of claim 3 further comprising:
a second double faced adhesive tape bondable to the top track outside wall and the top length compensation outer portion adjacent the top track first end and the top track second end, and
a third double faced adhesive tape bondable to the bottom track outside wall and the bottom length compensation outer portion adjacent the bottom track first end and the bottom track second end.

5. The foldable blind of claim 4 further comprising:
a pin axis at least one of engageably coupled and bypassing to the plurality of lift ropes; and
a set of wire parts located in the top track first end and the top track second end; and
wherein the line lock is located in the top track and between the foam strips and the set of wire parts,
the lift ropes are connected to the bottom track first end, and the lift ropes bypass the cord fabric and the top track and the pin axis are located on the bottom track second end.

6. The foldable blind of claim 1 wherein:
the top length compensation portions are used to adjust the top length at the top track first end and at the top track second end;
the bottom length compensation portions are used to adjust the bottom length at the bottom track first end and at the bottom track second end; and
a fourth double faced adhesive tape is bondable to the cord fabric.

7. The foldable blind of claim 6 wherein:
the top track has a top connecting trough and the line lock is located in the top track second end;
the bottom track has a bottom connecting trough and has a plurality of through-holes on the bottom track for the lift ropes to go through; and
when the bottom length of the bottom length compensation portion is adjusted, the through-holes and the bottom connecting trough coincide.

8. The foldable blind of claim 5, the line lock further comprising:
an installation platform having an installation cavity;
a roller connected to the installation platform and located on an installation cavity first end in a rotary manner;
an inner wall having a jugged trough on the installation cavity on an end opposite the roller;
a jugged axis located in the installation cavity in a flexible manner and meshing with the jugged trough, the jugged trough having an upper aperture and the roller is smaller than the jugged axis, the jugged trough having an arc shape and the bottom extends in a direction away from the roller; and
a spacing part fastened on the installation platform and going through the bottom of the installation cavity to prevent the jugged axis from falling out; and
wherein the lift ropes go through the space between the roller and the jugged axis and go through the sides of the spacing part.

9. The foldable blind of claim 7, the line lock further comprising:
an installation platform having an installation cavity;
a roller connected to the installation platform and located on an end of the installation cavity in a rotary manner;
a jugged trough on an inner wall of the installation cavity on an end opposite the roller;
a jugged axis located in the installation cavity in a flexible manner and meshing with the jugged trough;
a spacing part fastened on the installation platform and going through the bottom of the installation cavity to prevent the jugged axis from falling out;
wherein the jugged trough has an upper aperture and the roller is smaller than the jugged axis;
wherein the jugged trough has an arc shape and the bottom extends in a direction away from the roller; and
wherein the lift ropes go through the space between the roller and the jugged axis and go through the sides of the spacing part.

10. The foldable blind of claim 9 wherein:
a top side of the cord fabric is detachably connected to the top track;
a bottom side of the cord fabric is detachably connected to the bottom track;
a spacing rod is located within the bottom track and is connected at a middle of the spacing rod to at least one lift rope; and
the lift ropes go through the line lock are connected to one another and fastened with a pull ring.

11. The foldable blind of claim 1 further comprising:
a second top track;
at least one distance adjustment part coupling the top track and the second top track, the at least one distance adjustment part comprises a plurality of first adjustment arms connected the top track and the second top track through a hinge joint;
an adjustment rod coupled to the first adjustment arms; and
a snap-fit block located on the top tracks adjacent to the first adjustment arms, wherein one end of the adjustment rod is fastened inside the snap-fit block; and
wherein the cord fabric is comprised of opaque textile processed by starching; and
another cord fabric is coupled to the second top track and is comprised of long-fiber Dacron textile processed by starching.

12. The foldable blind of claim 2 further comprising:
a second top track;
at least one distance adjustment part coupling the top track and the second top track, the at least one distance adjustment part comprises a plurality of first adjustment arms connected the top track and the second top track through a hinge joint;
an adjustment rod coupled to the first adjustment arms; and
a snap-fit block located on the top tracks adjacent to the first adjustment arms, wherein one end of the adjustment rod is fastened inside the snap-fit block; and
wherein the cord fabric is comprised of opaque textile processed by starching; and
another cord fabric is coupled to the second top track and is comprised of long-fiber Dacron textile processed by starching.

13. The foldable blind of claim 3 further comprising:
a second top track;
at least one distance adjustment part coupling the top track and the second top track, the at least one distance adjustment part comprises a plurality of first adjustment arms connected the top track and the second top track through a hinge joint;
an adjustment rod coupled to the first adjustment arms; and
a snap-fit block located on the top tracks adjacent to the first adjustment arms, wherein one end of the adjustment rod is fastened inside the snap-fit block; and
wherein the cord fabric is comprised of opaque textile processed by starching; and
another cord fabric is coupled to the second top track and is comprised of long-fiber Dacron textile processed by starching.

14. The foldable blind of claim 4 further comprising:
a second top track;
at least one distance adjustment part coupling the top track and the second top track, the at least one distance adjustment part comprises a plurality of first adjustment arms connected the top track and the second top track through a hinge joint;
an adjustment rod coupled to the first adjustment arms; and
a snap-fit block located on the top tracks adjacent to the first adjustment arms, wherein one end of the adjustment rod is fastened inside the snap-fit block; and
wherein the cord fabric is comprised of opaque textile processed by starching; and
another cord fabric is coupled to the second top track and is comprised of long-fiber Dacron textile processed by starching.

15. The foldable blind of claim 5 further comprising:
a second top track;
at least one distance adjustment part coupling the top track and the second top track, the at least one distance adjustment part comprises a plurality of first adjustment arms connected the top track and the second top track through a hinge joint;
an adjustment rod coupled to the first adjustment arms; and
a snap-fit block located on the top tracks adjacent to the first adjustment arms, wherein one end of the adjustment rod is fastened inside the snap-fit block; and
wherein the cord fabric is comprised of opaque textile processed by starching; and
another cord fabric is coupled to the second top track and is comprised of long-fiber Dacron textile processed by starching.

16. The foldable blind of claim 6 further comprising:
a second top track;
at least one distance adjustment part coupling the top track and the second top track, the at least one distance adjustment part comprises a plurality of first adjustment arms connected the top track and the second top track through a hinge joint;
an adjustment rod coupled to the first adjustment arms; and
a snap-fit block located on the top tracks adjacent to the first adjustment arms, wherein one end of the adjustment rod is fastened inside the snap-fit block; and
wherein the cord fabric is comprised of opaque textile processed by starching; and
another cord fabric is coupled to the second top track and is comprised of long-fiber Dacron textile processed by starching.

17. The foldable blind of claim 7 further comprising:
a second top track;
at least one distance adjustment part coupling the top track and the second top track, the at least one distance adjustment part comprises a plurality of first adjustment arms connected the top track and the second top track through a hinge joint;
an adjustment rod coupled to the first adjustment arms; and
a snap-fit block located on the top tracks adjacent to the first adjustment arms, wherein one end of the adjustment rod is fastened inside the snap-fit block; and
wherein the cord fabric is comprised of opaque textile processed by starching; and
another cord fabric is coupled to the second top track and is comprised of long-fiber Dacron textile processed by starching.

18. The foldable blind of claim 8 further comprising:
a second top track;
at least one distance adjustment part coupling the top track and the second top track, the at least one distance adjustment part comprises a plurality of first adjustment arms connected the top track and the second top track through a hinge joint;
an adjustment rod coupled to the first adjustment arms; and
a snap-fit block located on the top tracks adjacent to the first adjustment arms, wherein one end of the adjustment rod is fastened inside the snap-fit block; and
wherein the cord fabric is comprised of opaque textile processed by starching; and
another cord fabric is coupled to the second top track and is comprised of long-fiber Dacron textile processed by starching.

19. The foldable blind of claim 9 further comprising:
a second top track;
at least one distance adjustment part coupling the top track and the second top track, the at least one distance adjustment part comprises a plurality of first adjustment arms connected the top track and the second top track through a hinge joint;
an adjustment rod coupled to the first adjustment arms; and
a snap-fit block located on the top tracks adjacent to the first adjustment arms, wherein one end of the adjustment rod is fastened inside the snap-fit block; and
wherein the cord fabric is comprised of opaque textile processed by starching; and
another cord fabric is coupled to the second top track and is comprised of long-fiber Dacron textile processed by starching.

20. The foldable blind of claim 10 further comprising:
a second top track;
at least one distance adjustment part coupling the top track and the second top track, the at least one distance adjustment part comprises a plurality of first adjustment arms connected the top track and the second top track through a hinge joint;
an adjustment rod coupled to the first adjustment arms; and
a snap-fit block located on the top tracks adjacent to the first adjustment arms, wherein one end of the adjustment rod is fastened inside the snap-fit block; and
wherein the cord fabric is comprised of opaque textile processed by starching; and
another cord fabric is coupled to the second top track and is comprised of long-fiber Dacron textile processed by starching.
